(19) United States
(12) Patent Application Publication
(10) Pub. No.: US 2024/0351325 A1
(43) Pub. Date: Oct. 24, 2024

(54) METHOD FOR MANUFACTURING MULTILAYER CERAMIC ELECTRONIC COMPONENTS

(71) Applicant: KYOCERA Corporation, Kyoto-shi, Kyoto (JP)

(72) Inventors: Hirotoshi ETO, Kirishima-shi (JP); Hisashi SATO, Kirishima-shi (JP)

(73) Assignee: KYOCERA Corporation, Kyoto-shi, Kyoto (JP)

(21) Appl. No.: 18/683,597

(22) PCT Filed: Aug. 3, 2022
(86) PCT No.: PCT/JP2022/029808

§ 371 Date: Feb. 14, 2024

(30) Foreign Application Priority Data
Aug. 24, 2021 (JP) 2021-136643

(51) Int. Cl. B32B 38/00; B32B 38/04; H01G 4/012; H01G 4/12; H01G 4/30

(52) U.S. Cl. CPC B32B 38/0004; B32B 38/04; H01G 4/012; H01G 4/1227; H01G 4/30; B32B 2038/042

(57) ABSTRACT

A method includes cutting a multilayer base including a plurality of dielectric ceramic bodies and a plurality of internal electrode layers alternately stacked on one another along a cutting line orthogonal to the multilayer base to obtain a plurality of base precursors each including a cut side surface on which the plurality of internal electrode layers is exposed, aligning the plurality of base precursors each to have the cut side surface being opened, applying an air remover to the cut side surface being opened, and placing a side green sheet into contact with the air remover applied to the cut side surface and pressing the side green sheet.

### TECHNICAL FIELD

The present invention relates to a method for manufacturing multilayer electronic components each including protective layers on side surfaces of a stack on which internal electrode layers are exposed.

### BACKGROUND OF INVENTION

A known technique is described in, for example, Patent Literature 1.

### CITATION LIST

### Patent Literature

Patent Literature 1: Japanese Patent No. 5780169

### SUMMARY

In an aspect of the present disclosure, a method for manufacturing multilayer ceramic electronic components includes cutting a multilayer base including a plurality of dielectric ceramic bodies and a plurality of internal electrode layers alternately stacked on one another along a cutting line orthogonal to the multilayer base to obtain a plurality of base precursors each including a cut side surface on which the plurality of internal electrode layers is exposed, aligning the plurality of base precursors each to have the cut side surface being opened, applying an air remover to the cut side surface being opened, and placing a side green sheet into contact with the air remover applied to the cut side surface and pressing the side green sheet.

In an aspect of the present disclosure, a method for manufacturing multilayer ceramic electronic components includes cutting a multilayer base including a plurality of dielectric ceramic bodies and a plurality of internal electrode layers alternately stacked on one another along a cutting line orthogonal to the multilayer base to obtain a plurality of base precursors each including a cut side surface on which the plurality of internal electrode layers is exposed, aligning the plurality of base precursors each to have the cut side surface being opened, applying an air remover to the cut side surface being opened, placing a side green sheet into contact with the air remover applied to the cut side surface and pressing the side green sheet, and removing a portion of the side green sheet other than a portion pressed against the cut side surface with a jet stream including dry ice microparticles.

### BRIEF DESCRIPTION OF THE DRAWINGS

FIG. 1 is a schematic perspective view of an example multilayer ceramic capacitor.

FIG. 2 is a schematic perspective view of a base component of the multilayer ceramic capacitor in FIG. 1.

FIG. 3 is a schematic perspective view of a precursor of the base component in FIG. 2.

FIG. 4 is a schematic perspective view of a ceramic green sheet on which internal electrode layers are printed.

FIG. 5 is a schematic perspective view of stacked ceramic green sheets on some of which the internal electrode layers are printed.

FIG. 6 is a schematic perspective view of a multilayer base for manufacturing multilayer ceramic capacitors illustrated in FIG. 1.

FIG. 7 is a schematic perspective view of base precursors obtained by cutting the multilayer base in FIG. 6.

FIG. 8 is a schematic perspective view of aligned base precursors.

FIG. 9A is a diagram of a base precursor immediately before its opened cut side surface is placed into contact with a nonwoven fabric impregnated with an air remover and placed on the bottom surface of a flat bottom pool.

FIG. 9B is a diagram of the base precursor with the air remover applied to the cut side surface.

FIG. 9C is a schematic diagram of a side green sheet being placed.

FIG. 9D is a schematic diagram of the base precursor with the air remover on the cut side surface being pressed against the side green sheet.

FIG. 10A is a schematic diagram of air trapped in a recess on the cut side surface after the air remover is applied.

FIG. 10B is a schematic diagram of the air trapped in the air remover.

FIG. 10C is a schematic diagram of the air being pushed away and removed from the cut side surface together with the air remover.

FIG. 11A is a schematic diagram illustrating margins of the side green sheet being cut with dry ice microparticles.

FIG. 11B is a schematic diagram of a support supporting margins of the side green sheet.

FIG. 12 is a schematic perspective view of base components with side green sheets being attached.

### DESCRIPTION OF EMBODIMENTS

The objects, features, and advantages of the present disclosure will become more apparent from the following detailed description and the drawings.

Recent wiring boards for electronic devices incorporate smaller electronic components with higher functions. Examples of such electronic components include multilayer ceramic capacitors.

Multilayer ceramic capacitors are to increase the capacitance achievable per unit volume. Such multilayer ceramic capacitors are thus to increase the area percentage of internal electrode layers by reducing the thickness of dielectric layers between the internal electrode layers and by reducing a margin portion of an outer shell that protects internal components.

For example, Patent Literature 1 describes a method for forming protective layers on green chips. The green chips are obtained by cutting a base block including internal electrode layers and ceramic green sheets stacked alternately on one another along orthogonal cut lines. The green chips are then spaced from one another using an expansion adhesive sheet and rotated to receive a thin side ceramic green sheet on their cut side surfaces on which the internal electrode layers are exposed.

Patent Literature 1 also describes using an adhesive to increase bonding to the ceramic protective layers and press-bonding the raw ceramic protective layers on the green chips with heat at a temperature of 200°° C. or lower.

However, the techniques described in Patent Literature 1 includes some issues. To place the green chips to be spaced from one another, the multiple green chips arranged in rows and columns are attached onto the expansion adhesive sheet, and the adhesive sheet is then expanded. The disposable expandable adhesive sheet increases component costs.

The use of an adhesive forms adhesive layers, which can trap air in, for example, recesses on the cut side surface. When firing is performed with air remaining between the cut side surface and a side green sheet for protecting the cut side surface, the portion trapping the air can be a void that can degrade insulation or reliability The green sheet is thus to be attached without air being trapped, although such method is not described.

Additionally, the adhesive used for attaching the side green sheet to the cut side surface is not specifically described. When a common adhesive is used, air can remain in recesses on the cut side surfaces to be small voids. Some adhesives can have voids inside with a gas generated in an adhesive layer area.

With a method of punching the side ceramic green sheet placed on an elastic member with the cut side surfaces being pressed against the elastic member, the elastic member is to be placed deeply between the components to reduce punching failure in punching the side ceramic green sheet with the corners of raw base precursors. This increases the space to be left between the components and may not allow processing many components at a time on a base plate.

One or more aspects of the present disclosure are directed to a method for manufacturing multilayer ceramic components that allows a side ceramic green sheet to be attached without air trapped in the cut side surfaces of multilayered green sheet.

The method for manufacturing the multilayer ceramic electronic components according to one or more embodiments of the present disclosure will be described below with reference to the drawings. A multilayer ceramic capacitor will now be described as an example multilayer ceramic electronic component. However, the multilayer ceramic electronic component to be manufactured in the embodiments of the present disclosure is not limited to the multilayer ceramic capacitor, and may be any of various other multilayer ceramic components such as a multilayer piezoelectric element, a multilayer thermistor element, a multilayer chip coil, and a multilayer ceramic substrate.

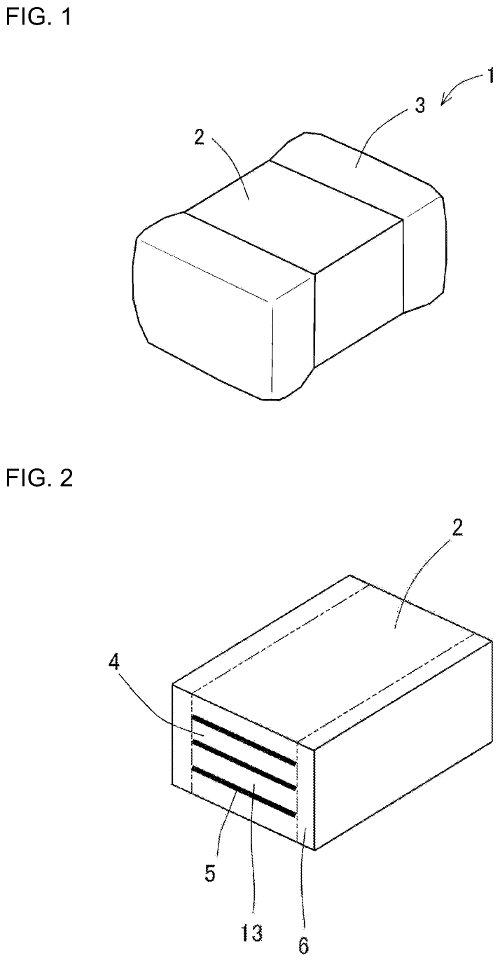

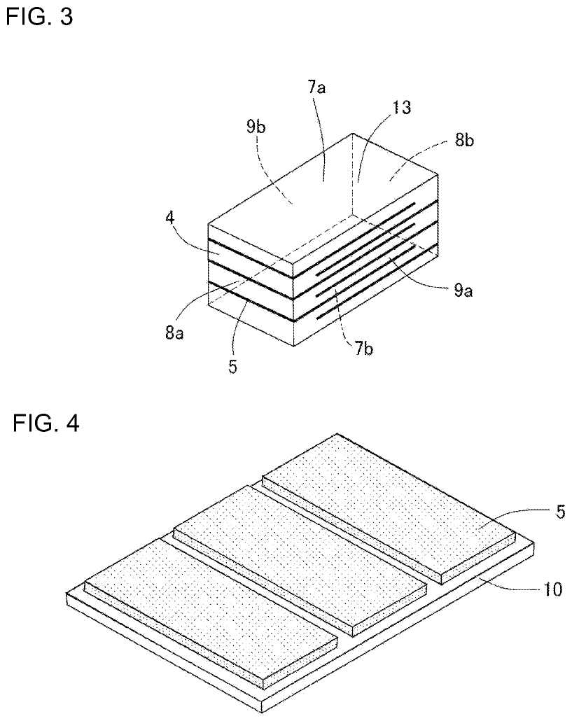

FIG. 1 is a perspective view of an example multilayer ceramic capacitor. A multilayer ceramic capacitor 1 as an example multilayer ceramic electronic component will be described first. FIG. 2 is a schematic perspective view of a base component of the multilayer ceramic capacitor in FIG. 1. FIG. 2 is a diagram of the base component before firing, as well as after firing. The base component shrinking after firing has the same structure as the base component before firing. FIG. 3 is a perspective view of a precursor of the base component in FIG. 2. The precursor of the base component may be hereafter referred to as a base precursor.

The multilayer ceramic capacitor 1 in FIG. 1 includes a base component 2 and external electrodes 3. As illustrated in FIG. 2, the base component 2 is substantially a rectangular prism. The base component 2 includes dielectric ceramic 4 and multiple internal electrode layers 5 connected to the external electrodes 3. The external electrodes 3 are located on a pair of end faces of the base component 2 and extend to other adjacent faces. The internal electrode layers 5 extend inward from either of the pair of end faces of the base component 2 and alternates without contact with each other.

Each external electrode 3 includes an underlayer connected to the base component 2 and a plated outer layer that facilitates mounting of external wiring to the external electrode 3 by soldering. The underlayer may be applied to the base component 2 after firing by thermal treatment. The underlayer may be placed on the base component 2 before firing and fired together with the base component 2. The external electrode 3 may include multiple underlayers and multiple plated outer layers to have an intended function. The external electrode 3 may include no plated outer layer and may include the underlayer and a conductive resin layer.

FIG. 3 is a schematic perspective view of the precursor of the base component in FIG. 2. The base component 2 includes a base precursor 13 in FIG. 3 with protective layers 6 attached to a pair of a first side surface 9a and a second side surface 9b. As illustrated in FIG. 3, the base precursor 13 is substantially a rectangular prism. The base precursor 13 includes a pair of a first main surface 7a and a second main surface 7b opposite to each other, a pair of a first end face 8a and a second end face 8b opposite to each other, and the pair of the first side surface 9a and the second side surface 9b opposite to each other.

The base precursor 13 includes the internal electrode layers 5 exposed on the first end face 8a and the second end face 8b and on the first side surface 9a and the second side surface 9b. The protective layers 6 are attached in a final process in manufacturing the base component 2. The protective layers 6 reduce the likelihood of electrical short-circuiting between the internal electrode layers 5 exposed on the first end face 8a and the internal electrode layers 5 exposed on the second end face 8b, in addition to physically protecting the first side surface 9a and the second side surface 9b. The protective layer 6 may be made of a highly insulating ceramic material having high mechanical strength. The boundaries between the base precursor 13 and the protective layers 6 indicated by the two-dot-dash lines in FIG. 2 actually appear unclear.

The method for manufacturing base components 2 in FIG. 2 and multilayer ceramic capacitors 1 will now be described. A ceramic mixture powder containing a ceramic dielectric material of BaTiO₃ with an additive is first wet-milled and blended using a bead mill. A polyvinyl butyral binder, a plasticizer, and an organic solvent are added to this milled and blended slurry and are mixed together to prepare ceramic slurry.

A die coater is then used to form a ceramic green sheet 10 on a carrier film. The ceramic green sheet 10 may have a thickness of, for example, about 1 to 10 μm. A thinner ceramic green sheet 10 can increase the capacitance of the multilayer ceramic capacitors. The ceramic green sheet 10 may not be formed by die coating, but may be formed by, for example, doctor blading or graphic coating.

FIG. 4 is a schematic perspective view of a ceramic green sheet on which the internal electrode layers are printed. As illustrated in FIG. 4, a conductive paste including a metal material, which is to be the internal electrode layers 5, is printed by screen printing on the prepared ceramic green sheet 10 in a predetermined pattern. The conductive paste may be printed by, for example, gravure printing, rather than by screen printing. The conductive paste may contain a metal such as Ni, Pd, Cu, or Ag or an alloy of these metals. In the example in FIG. 3, the internal electrode layers 5 are in strip patterns in multiple rows. In some embodiments, the internal electrode layers 5 may be in, for example, an individual electrode pattern.

Thinner internal electrode layers 5 that allow the capacitor to function can reduce internal defects resulting from internal stress. For a capacitor with a stack of many layers, the internal electrode layers 5 may each have, for example, a thickness less than or equal to 1.0 μm.

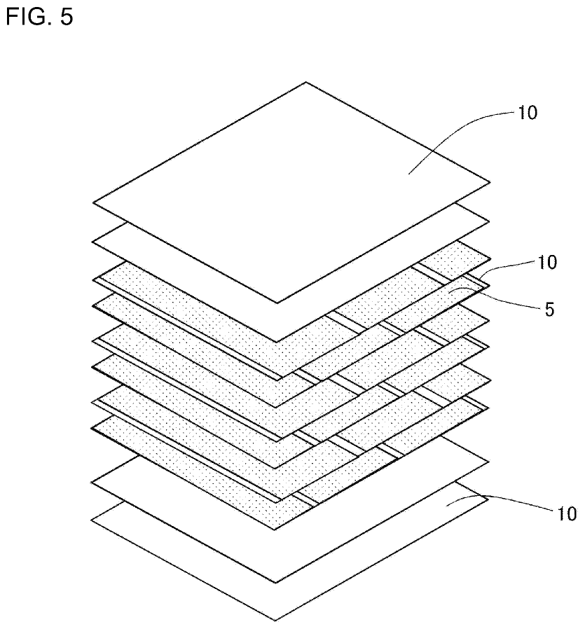

FIG. 5 is a schematic perspective view of stacked ceramic green sheets on some of which the internal electrode layers are printed. As illustrated in FIG. 5, a predetermined number of ceramic green sheets 10 with printed internal electrode layers 5 are stacked on a stack of a predetermined number of ceramic green sheets 10, and a predetermined number of ceramic green sheets 10 are stacked on the stack of ceramic green sheets 10 with the printed internal electrode layers 5. The predetermined number of ceramic green sheets 10 with the printed internal electrode layers 5 are stacked to have the patterns of the internal electrode layers 5 deviating from each other. Although not illustrated in FIG. 5, the ceramic green sheets 10 are stacked on a support sheet. The support sheet may be an adhesive releasable sheet, such as a low-tack sheet or a foam releasable sheet.

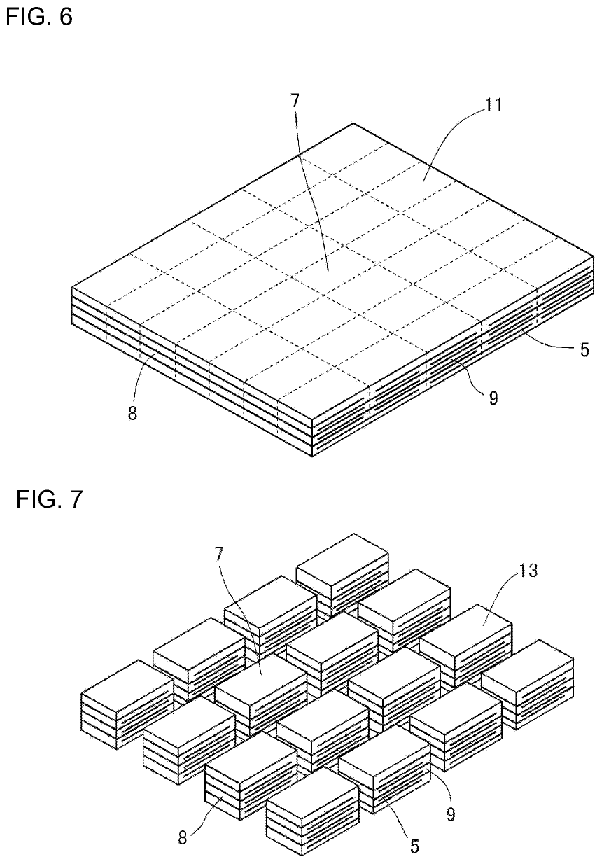

FIG. 6 is a schematic perspective view of a multilayer base for manufacturing multilayer ceramic capacitors illustrated in FIG. 1. The stack of multiple layers of the ceramic green sheets 10 is then pressed in the stacking direction to obtain an integrated multilayer base 11 as illustrated in FIG. 6. The stack may be pressed using, for example, a hydrostatic press device. In the multilayer base 11, the internal electrode layers 5 are buried in layers between the ceramic green sheets 10. Although not illustrated in FIG. 6, the support sheet, which is used in stacking the ceramic green sheets 10, is located under the multilayer base 11. The orthogonal broken lines illustrated in FIG. 6 are cutting lines indicating the positions for cutting.

FIG. 7 is a schematic perspective view of base precursors obtained by cutting the multilayer base in FIG. 6. As illustrated in FIG. 7, the multilayer base 11 is cut into multiple base precursors 13 illustrated in FIG. 3 with predetermined dimensions using a press-cutting device. The multilayer base 11 may be cut with any device other than a press-cutting device. For example, the multilayer base 11 may be cut with a dicing saw. The main surfaces, the end faces, and the side surfaces of the multilayer base 11, corresponding respectively to the main surfaces 7, the end faces 8, and cut side surfaces 9 of the base precursors 13, are hereafter denoted with the same reference signs.

A reception tray (not illustrated) including pockets (not illustrated) aligned vertically and laterally for receiving the respective base precursors 13 is then prepared. The base precursors 13 are aligned in the reception tray with their cut side surfaces 9 facing upward. An adhesive and releasable support sheet 18 is then placed over the base precursors 13 to fix the base precursors 13 to the support sheet 18.

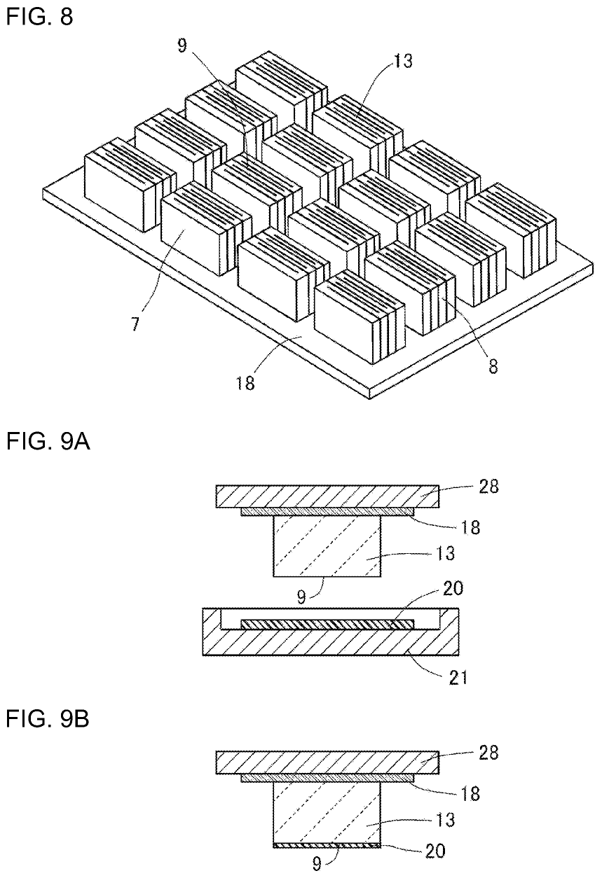

FIG. 8 illustrates the base precursors 13 fixed to the support sheet 18 after the reception tray is removed. As illustrated in FIG. 8, the cut side surfaces 9 of the base precursors 13 are opened.

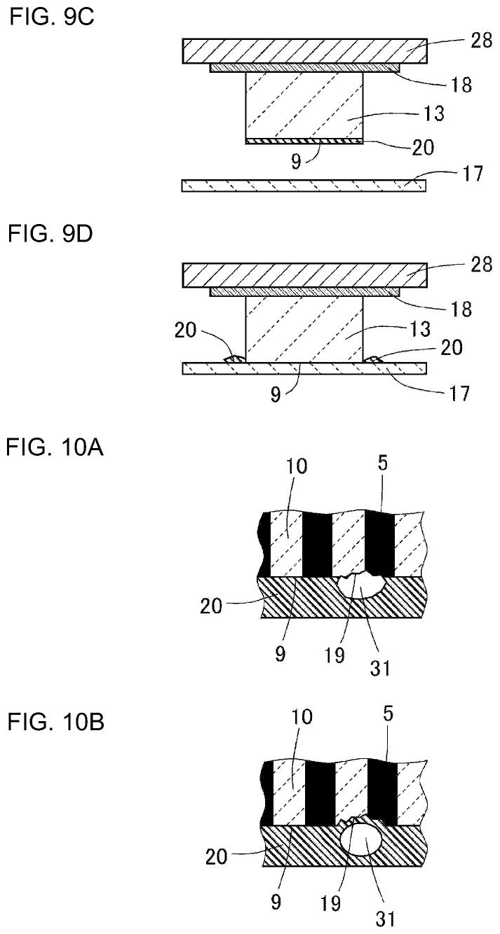

The process of attaching a side green sheet 17 to the cut side surfaces 9 of the base precursors 13 will now be described with reference to FIGS. 9A to 9D. FIG. 9A illustrates a base precursor 13 immediately before its opened cut side surface 9 is placed into contact with a nonwoven fabric impregnated with an air remover 20 located on the bottom surface of a flat bottom pool 21. FIG. 9B illustrates the base precursor 13 with the air remover 20 applied to the cut side surface 9.

The air remover 20 may be a liquid having a low drying rate and does not dissolve the materials of the base precursor 13 and the side green sheet 17, in addition to having higher wettability for the base precursor 13 and the side green sheet 17. The air remover 20 is applied to the cut side surface 9, placed into contact with the side green sheet 17, and pressed against the side green sheet 17. During these processes, the air remover 20 remains in the liquid state without permeating into the base precursor 13 or the side green sheet 17 or disappearing. For example, the use of a solvent may be avoided to avoid the above situation. Solvents, which dissolve the side green sheet 17, has high wettability. However, when solvents dissolve the surface of the cut side surface 9, Ni particles on the surface of the cut side surface 9 move. This may cause short-circuiting between adjacent exposed internal electrode layers.

As illustrated in FIG. 9C, the side green sheet 17 is prepared. The side green sheet 17 may be a stack of multiple green sheets, or a stack of green sheets with different compositions.

As illustrated in FIG. 9D, the air remover 20 on the cut side surface 9 of the base precursor 13 is placed into contact with the side green sheet 17, and the base precursor 13 is pressed against the side green sheet 17 using a press. The air remover 20 between the cut side surface 9 and the side green sheet 17 is pushed out of the cut side surface 9 and discharged to margins of the side green sheet 17. When the pressing force is weak, the air remover 20 is not removed from the cut side surface 9. When the press force is too strong, the base precursor 13 before firing deforms. The pressing force may be 30 to 100 Kg/cm².

In this process, the side green sheet 17 is to be attached without trapping air. When air remains between the cut side surface 9 and the side green sheet 17 for protecting the cut side surface 9 while firing, the air portion becomes a void that can degrade insulation or reliability. The cut side surface 9 coated with the air remover 20 with high wettability is uniformly wet. For the cut side surface 9 having any microscopic recesses, the air remover 20 spreads over the surface and wets the surface to separate the air confined in the recesses from the cut side surface 9. In the subsequent pressing process, the air remover 20 is pushed out of the cut side surface 9, discharging the air trapped in the air remover 20. The air remover 20 may have wettability for the cut side surface 9 with a contact angle of near 0, with the liquid spreading over the solid surface to wet the solid surface.

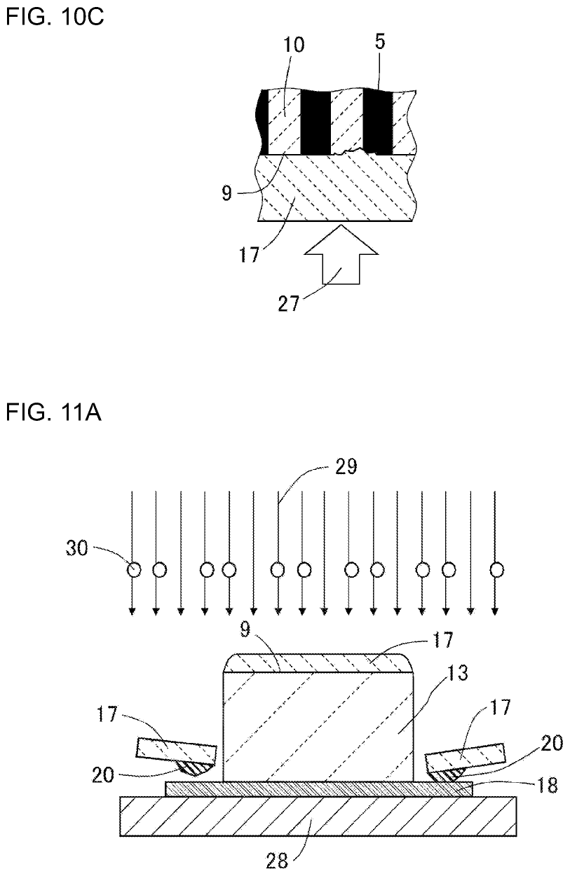

The effects of an air remover with the liquid spreading over the solid surface to wet the surface will now be described. FIG. 10A schematically illustrates air 31 trapped in a recess 19 on the cut side surface 9 after the air remover 20 is applied. Although the portion of the cut side surface 9 trapping the air 31 is not wet at the beginning, the air remover 20 gradually spreads and wets the entire surface of the cut side surface 9, causing the air 31 to be trapped in the air remover 20 as illustrated in FIG. 10B.

In the present embodiment, a plasticizer is used as the air remover 20. The plasticizer, which increases the plasticity of the binder in the base precursor 13 or the binder in the side green sheet 17, has wettability high enough to spread over the base precursor 13. The plasticizer can thus fully wet the surface of the base precursor 13 without dissolving the base precursor 13. When, for example, the plasticizer is applied to the cut side surface 9 with the air 31 remaining in the recess 19, the plasticizer spreads onto the cut side surface 9 trapping the air 31 as the plasticizer wets the cut side surface 9. The air 31 is then separated from the cut side surface 9 as illustrated in FIG. 10B. When the plasticizer is pushed and removed from the cut side surface 9 in the subsequent pressing process, the air 31 is pushed and removed from the cut side surface 9 together with the plasticizer as illustrated in FIG. 10C.

The plasticizer in contact with the binder in the surface of the base precursor 13 or the side green sheet 17 increases the plasticity of the binder in the surface in contact with the plasticizer. The plasticizer also increases the plasticity of the binder in the surface onto which the side green sheet 17 is attached. This allows effective press-bonding.

For the binder used for the green sheet in the present embodiment being a polyvinyl butyral resin binder, the plasticizer may be an ester with high compatibility, such as a phthalate ester including dioctyl phthalate (DOP), bis (2-ethylhexyl) phthalate (DEHP), or dibutyl phthalate (DBP), a phosphate ester, or a fatty acid ester.

In the pressing process, the side green sheet 17 may be placed on a flat hard base plate to achieve reliable discharge of the air remover 20. However, to allow variations in the dimensions of the base precursors 13, a flexible sheet may be held in a press. In this case, an elastic member such as a thin silicone rubber plate may be placed between the support sheet 18 for the base precursors 13 and a press punch (not illustrated), not nearer the side green sheet 17.

FIG. 11A is a schematic diagram illustrating the margins of the side green sheet being cut with dry ice microparticles. After the air remover 20 is applied and removed as described above, the margins of the side green sheet 17 (portions other than the portions pressed against the cut side surface 9) are removed by cutting. A jet stream containing dry ice microparticles 30 is used to remove the portions of the side green sheet 17 other than the portions pressed against the cut side surface 9. When hitting the side green sheet 17, the dry ice microparticles 30 receive heat from the side green sheet 17 and evaporate. This lowers the temperature of the side green sheet 17, causing the side green sheet 17 to be less flexible. In this state, the impact of the jet stream and the dry ice is applied to the side green sheet 17 and bends the margins of the side green sheet 17 not supported from below. The side green sheet 17 is thus torn off and cut at the edges of the cut side surface 9 of the base precursor 13. This is because the portion of the side green sheet 17 inward from the edges is pressed against the cut side surface 9 by a jet of dry ice whereas the portion of the side green sheet 17 outward from the edges under a tensile force acting in the bending direction receives the dry ice microparticles 30 hitting the edges. The air remover 20 removed from the cut side surface 9 scatters while remaining on the torn portion of the side green sheet 17.

FIG. 11B is a schematic diagram of a support supporting margins of the side green sheet. The aligned base precursors 13 are surrounded by a support 51 supporting the portions other than the portions pressed against the cut side surfaces 9. The support 51 allows the portion of the side green sheet 17 at the periphery of the aligned base precursors 13 to be cut in the same environment as the portion of the side green sheet 17 in the middle of the aligned base precursors 13, achieving less processing time and uniform cutting quality.

The dry ice nozzle used was a nozzle that can jet high-pressure air in a jet stream containing dry ice microparticles. The air pressure was in a range of 0.2 MPa, which is the minimum pressure for cutting the sheets, to 0.5 MPa, which is the maximum pressure for feeding air in factories. The distance between the dry ice nozzle and the cut side surfaces as the target surfaces was set to 20 to 80 millimeters, determined as appropriate for the size of a base plate 28. When the distance to the target surfaces is larger than or equal to 80 millimeters, cutting is difficult at the maximum air pressure of 0.5 MPa. The jet stream attenuates, and the microparticulate dry ice can evaporate before hitting and thus have a smaller hitting effect. The dry ice microparticles used were microparticles with an average particle diameter less than or equal to 100 micrometers as observed with high-speed photography. The bases of the multilayer ceramic components before firing have soft surfaces. Particles with a greater average particle diameter thus gradually grind the surfaces and form recesses on the surface of the side green sheet.

The cutting using a jet stream of dry ice microparticles allows the distance between workpieces to be small enough for the stream to pass through the workpieces, thus allowing more workpieces to be placed on the base plate 28.

When a stream is not used, for example, the margins may be removed by pressing an elastic member against base components to place the elastic member between the base components and punching out the margins at the edges of the cut side surfaces. Such processing is difficult with a smaller distance between the base components.

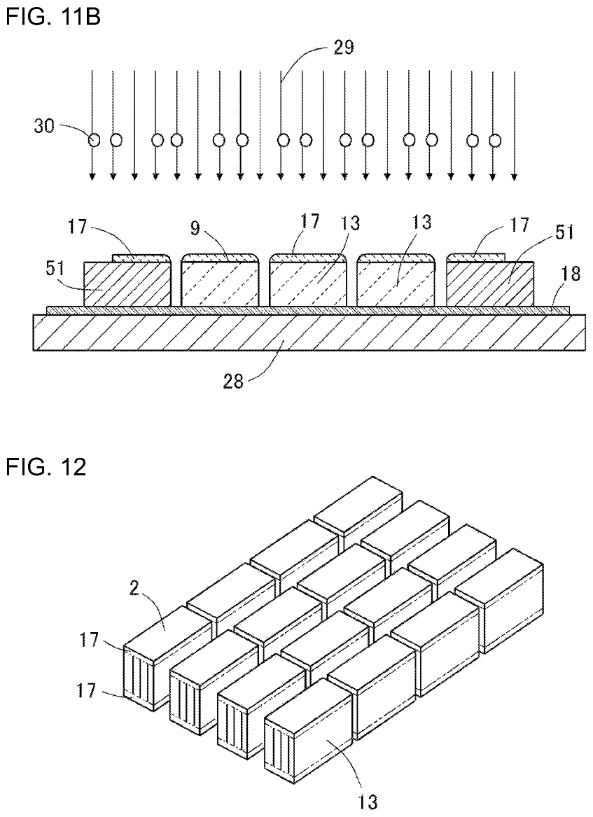

The processes described above from applying the air remover to removing the margins of the side green sheet by cutting are performed also on the opposite cut exposed surface in the same or similar manner. FIG. 12 is a diagram of raw base components 2 obtained from the processes described above. The side green sheet serving as the protective layers is attached to the pairs of cut side surfaces.

The obtained base components were degreased in a nitrogen atmosphere, and then fired in a hydrogen-nitrogen atmosphere. After firing, a conductive paste is applied and baked, and the external electrodes are formed to obtain multilayer ceramic capacitors 1 in FIG. 1.

The present disclosure may be implemented in the following forms.

In one or more embodiments of the present disclosure, a method for manufacturing multilayer ceramic electronic components includes cutting a multilayer base including a plurality of dielectric ceramic bodies and a plurality of internal electrode layers alternately stacked on one another along a cutting line orthogonal to the multilayer base to obtain a plurality of base precursors each including a cut side surface on which the plurality of internal electrode layers is exposed, aligning the plurality of base precursors each to have the cut side surface being opened, applying an air remover to the cut side surface being opened, and placing a side green sheet into contact with the air remover applied to the cut side surface and pressing the side green sheet.

In one or more embodiments of the present disclosure, a method for manufacturing multilayer ceramic electronic components includes cutting a multilayer base including a plurality of dielectric ceramic bodies and a plurality of internal electrode layers alternately stacked on one another along a cutting line orthogonal to the multilayer base to obtain a plurality of base precursors each including a cut side surface on which the plurality of internal electrode layers is exposed, aligning the plurality of base precursors each to have the cut side surface being opened, applying an air remover to the cut side surface being opened, placing a side green sheet into contact with the air remover applied to the cut side surface and pressing the side green sheet, and removing a portion of the side green sheet other than a portion pressed against the cut side surface with a jet stream including dry ice microparticles.

In one or more embodiments of the present disclosure, the above method for manufacturing multilayer ceramic electronic components removes a void at the boundary between the cut side surface and the side margin layer of each base component. This method reduces degradation of insulation or reliability that are to be the product characteristics after firing.

In one or more embodiments of the present disclosure, the above method for manufacturing multilayer ceramic electronic components allows efficient removal of margins of the side green sheet for attaching the side green sheet to the side surface of the stack by cutting.

### REFERENCE SIGNS

1 multilayer ceramic capacitor

2 base component

3 external electrode

4 dielectric ceramic

5 internal electrode layer

6 protective layer

7 main surface

7a first main surface

7b second main surface

8 end face

8a first end face

8b second end face

9 cut side surface

9a first side surface

9b second side surface

10 ceramic green sheet

11 multilayer base

13 base precursor

17 side green sheet

18 support sheet

19 recess

20 air remover

21 flat bottom pool

22 reception tray

23 pocket

27 pressing

28 base plate

29 jet stream

30 dry ice microparticle

31 air

51 support

1. A method for manufacturing multilayer ceramic electronic components, the method comprising:
cutting a multilayer base including a plurality of dielectric ceramic bodies and a plurality of internal electrode layers alternately stacked on one another along a cutting line orthogonal to the multilayer base to obtain a plurality of base precursors, each of the plurality of base precursors including a cut side surface on which the plurality of internal electrode layers is exposed;
aligning the plurality of base precursors each to have the cut side surface being opened;
applying an air remover to the cut side surface being opened; and
placing a side green sheet into contact with the air remover applied to the cut side surface and pressing the side green sheet.

2. The method according to claim 1, wherein
the air remover is a plasticizer.

3. The method according to claim 1, wherein
the side green sheet is pressed using a press with an elastic member placed between a press punch and a support sheet on which the plurality of base precursors is placed.

4. The method according to claim 1, further comprising:
removing a portion of the side green sheet other than a portion pressed against the cut side surface with a jet stream including dry ice microparticles.

5. The method according to claim 4, further comprising:
placing a support at a periphery of the aligned plurality of base precursors to support the portion of the side green sheet other than the portion pressed against the cut side surface.

6. A method for manufacturing multilayer ceramic electronic components, the method comprising:
cutting a multilayer base including a plurality of dielectric ceramic bodies and a plurality of internal electrode layers alternately stacked on one another along a cutting line orthogonal to the multilayer base to obtain a plurality of base precursors, each of the plurality of base precursors including a cut side surface on which the plurality of internal electrode layers is exposed;
aligning the plurality of base precursors each to have the cut side surface being opened;
applying an air remover to the cut side surface being opened;
placing a side green sheet into contact with the air remover applied to the cut side surface and pressing the side green sheet; and
removing a portion of the side green sheet other than a portion pressed against the cut side surface with a jet stream including dry ice microparticles.
